(19) United States
(12) Patent Application Publication
(10) Pub. No.: US 2009/0174762 A1
(43) Pub. Date: Jul. 9, 2009

(54) MOBILE COMMUNICATION APPARATUS

(75) Inventor: Junichi Takahashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/138,685

(22) Filed: Jun. 13, 2008

(30) Foreign Application Priority Data
Jun. 13, 2007 (JP) 2007-156499

(51) Int. Cl. H04N 7/14

(52) U.S. Cl. 348/14.02; 348/E07.077

(57) ABSTRACT

While executing a videophone communication between two mobile communication apparatuses, one of the two mobile communication apparatuses requests the other mobile communication apparatus to change a transmission destination of video or audio data to a further communication apparatus. Responding to the request, the other mobile communication apparatus switches the transmission destination and source, which the video or audio data is to be transmitted to and received from, to the further communication apparatus designated in the request.

### CROSS-REFERENCE TO RELATED APPLICATIONS

This application is based upon and claims the benefit of priority from prior Japanese Patent Application No. 2007-156499, filed Jun. 13, 2007, the entire contents of which are incorporated herein by reference.

### BACKGROUND OF THE INVENTION

1. Field of the Invention

The present invention relates to a mobile communication apparatus, and particularly to a mobile communication apparatus capable of communicating with plural communication terminals.

2. Description of the Related Art

A videophone system is a known information transmission system which conveys plural kinds of data. In such a videophone system, video data and audio data (used herein to refer to speech data and/or other audio data) are transmitted in a multiplexed form. A mobile communication apparatus used in the videophone system is equipped with a camera for capturing video data to be transmitted, a display for displaying received video data, a microphone for inputting audio data to be transmitted, and a speaker for outputting received audio data.

There are cases in which one or more of the camera, the display, the microphone, or the speaker are not suitable for the communication. For example, since a mobile communication apparatus is designed to be portable, its display is usually compact. Therefore, if plural users need to watch displayed video data when executing videophone service, it is preferable that a television or personal computer having a large display be used for displaying the received video data.

In view of this situation, a removable large display module for displaying a TV program received via the mobile communication apparatus has been provided. By utilizing the removable large display module, users can enjoy videophone service on a large display, or may remove the display module in order to carry the mobile communication apparatus more easily.

However, the removable large display module does not necessarily satisfy the needs of the user. For example, the user cannot readily replace a display module with another one suitable for displaying specific video data since it may be inconvenient for the user to prepare many types of removable displays.

Japanese publication JP-A-2004-248165 discloses another approach, in which a communication apparatus can switch a session on which a videophone service is executed to another communication apparatus. However, this method does not easily allow a user to switch the session to a mobile communication terminal suitable for executing the videophone service.

### BRIEF SUMMARY OF THE INVENTION

According one aspect of the present invention, a mobile communication apparatus is provided, which includes: a radio interface configured to establish a communication session with a base station; a communication unit configured to receive encoded video data and encoded audio data from a first communication apparatus via the communication session; a session control unit configured to request the first communication apparatus to transmit the encoded video data and the encoded audio data to a second communication apparatus; a decoding unit configured to decode the encoded video data and the encoded audio data; and a decoding control unit configured to stop decoding the encoded video data and encoded audio data when designated by the session control unit.

### BRIEF DESCRIPTION OF THE DRAWINGS

FIG. 1 is a block diagram showing the construction of a communication system containing a communication apparatus according to an embodiment of the present invention;

FIG. 2 is a block diagram showing the construction of a mobile communication apparatus according to the embodiment of the present invention;

FIG. 3 is a block diagram showing the construction of a transceiver of the mobile communication apparatus according to the embodiment of the present invention;

FIG. 4 is a block diagram showing the construction of an encoder of the mobile communication apparatus according to the embodiment of the present invention;

FIG. 5 is a block diagram showing a decoder of the mobile communication apparatus according to the embodiment of the present invention;

FIG. 6 is a block diagram showing the construction of a personal computer according to the embodiment of the present invention;

FIG. 7 is a block diagram showing the construction of a transceiver of the personal computer according to the embodiment of the present invention;

FIG. 8 is a block diagram showing the construction of a video encoder of the personal computer according to the embodiment of the present invention;

FIG. 9 is a block diagram showing the construction of a video decoder of the personal computer according to the embodiment of the present invention;

FIG. 10 is a diagram showing a refresh period and a video frame time which are detected by a video frame time manager according to the embodiment of the present invention;

FIG. 11 is a diagram showing a refresh period and a video frame time which are detected by a video frame time manager according to the embodiment of the present invention;

FIG. 12 is a diagram showing the construction of a session status according to the embodiment of the present invention;

FIG. 13 is a diagram showing the construction of the session status according to the embodiment of the present invention;

FIG. 14 is a diagram showing the construction of the session status according to the embodiment of the present invention;

FIG. 15 is a diagram showing the construction of the session status according to the embodiment of the present invention;

FIG. 16 is a diagram showing the construction of the session status according to the embodiment of the present invention;

FIG. 17 is a flowchart showing of the control operation of a controller of a second mobile communication apparatus according to the embodiment of the present invention;

FIG. 18 is a flowchart showing the control operation of the controller of the first mobile communication apparatus according to the embodiment of the present invention; and

FIG. 19 is a flowchart showing the control operation of the controller of the personal computer according to the embodiment of the present invention.

### DETAILED DESCRIPTION

Embodiments of the present invention will be described below with reference to the accompanying drawings.

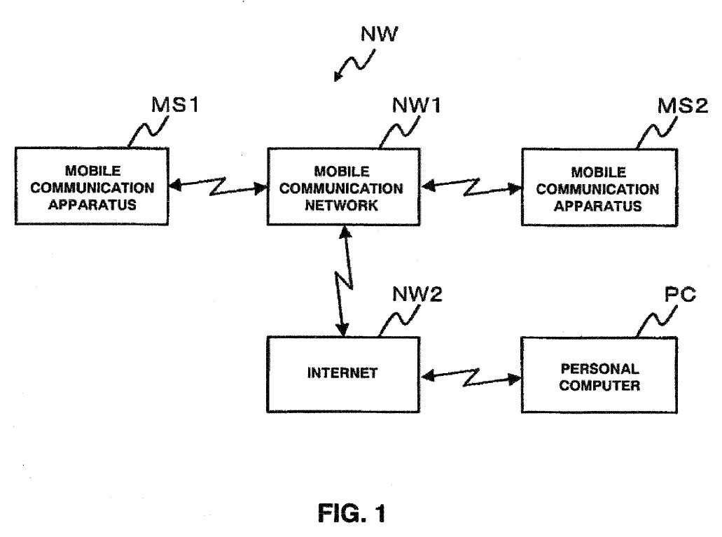

FIG. 1 is a block diagram showing the construction of a communication system containing a mobile communication apparatus such as a cellular phone according to one embodiment.

In the communication system shown in FIG. 1, first and second mobile communication apparatuses MS1 and MS2 and a personal computer PC are connected to each other through a communication network NW.

The communication network NW includes a mobile communication network NW1 and an Internet network NW2, which are connected to each other so that data can be transmitted/received therebetween. The first mobile communication apparatus MS1 and the second mobile communication apparatus MS2 are connected to the mobile communication network NW1, and the personal computer PC is connected to the Internet network 1W2.

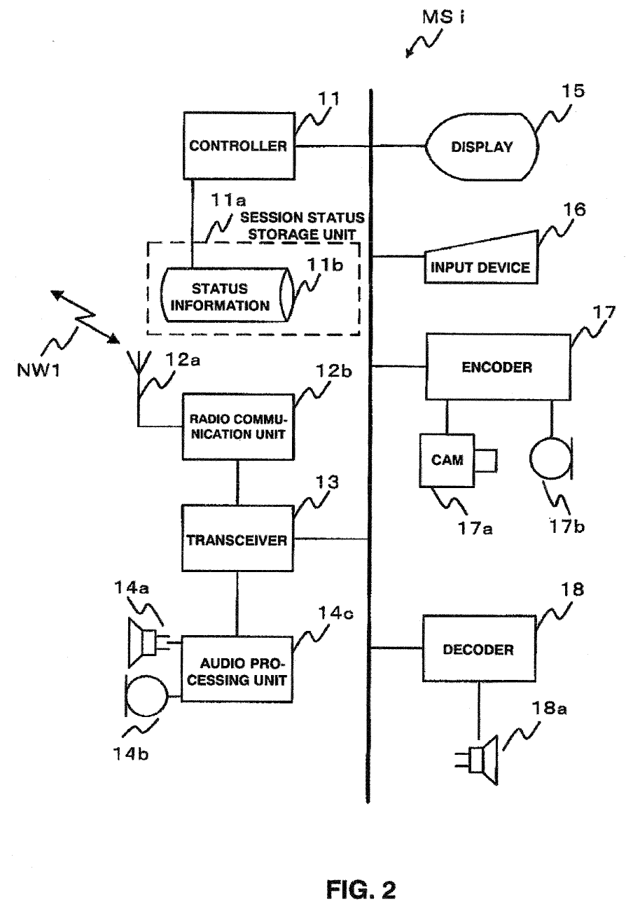

FIG. 2 is a block diagram showing the construction of a mobile communication apparatus MSi (In this embodiment, i represents 1 or 2.). The mobile communication apparatus MSi includes a controller 11 for controlling the mobile communication apparatus MSi overall, a session status storage unit 11a, an antenna 12a which is connected to the mobile communication network NW1, a radio communication unit 12b, a transceiver 13, a first speaker 14a, a first microphone 14b, an audio processing unit 14c, a display 15, an input device 16, an encoder 17, a camera 17a, a second microphone 17b, a decoder 18 and a second speaker 18a. Session status information 11b is stored in the session status storage unit 11a.

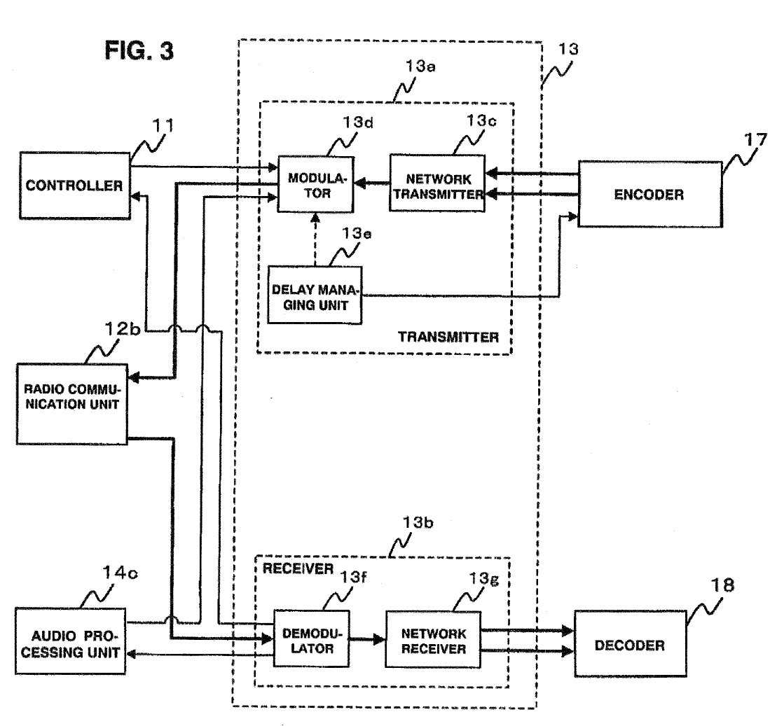

FIG. 3 is a block diagram showing the detailed construction of the transceiver 13 of the mobile communication apparatus MSi. The transceiver 13 has a transmitter 13a and a receiver 13b. The transmitter 13a is equipped with: a network transmitter 13c connected to the encoder 17; a modulator 13d connected to the controller 11, the radio communication unit 12b and the audio processing unit 14c; and a delay managing unit 13e connected to the encoder 17. The receiver 13b is equipped with: a demodulator 13f connected to the controller 11, the radio communication unit 12b and the audio processing unit 14c; and a network receiver 13g connected to the decoder 18.

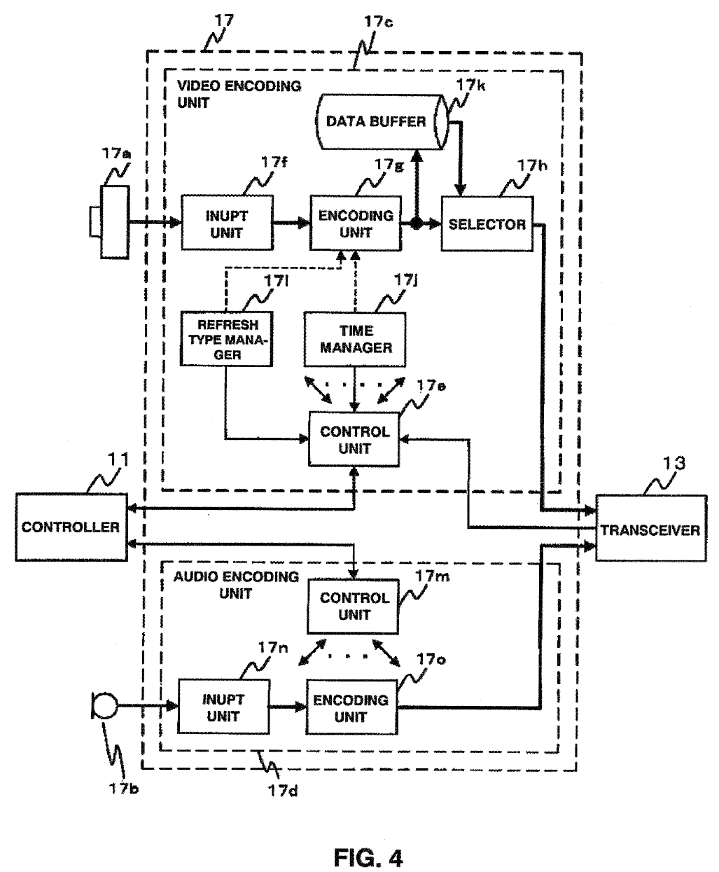

FIG. 4 is a block diagram showing the detailed construction of the encoder 17 of the mobile communication apparatus MSi. The encoder 17 has a video encoding unit 17c and an audio encoding unit 17d. The video encoding unit 17c is connected to the controller 11, the transceiver 13, and the camera 17a. The video encoding unit 17c includes a video encoding control unit 17e for controlling the respective parts of the video encoding unit 17c, a video data input unit 17f connected to the camera 17a, a video data encoding unit 17g, a video data selector 17h connected to the transceiver 13, a refresh type manager 17i, a time manager 17j, and a data buffer 17k which stores encoded video data encoded by the video data encoding unit 17g.

The audio encoding unit 17d is connected to the controller 11, transceiver 13, and the second microphone 17b. The audio encoding unit 17d includes an audio encoding controlling unit 17m for controlling the respective parts of the audio encoding unit 17d, an audio data input unit 17n connected to the second microphone 17b, and an audio data encoding unit 17o connected to the transceiver 13.

In FIGS. 3-5 and 7-9, heavy solid-line arrows represent the flow of the video data and/or the audio data, dashed-line arrows represent one unit referring to another unit, and solid-line arrows represent one unit controlling another unit.

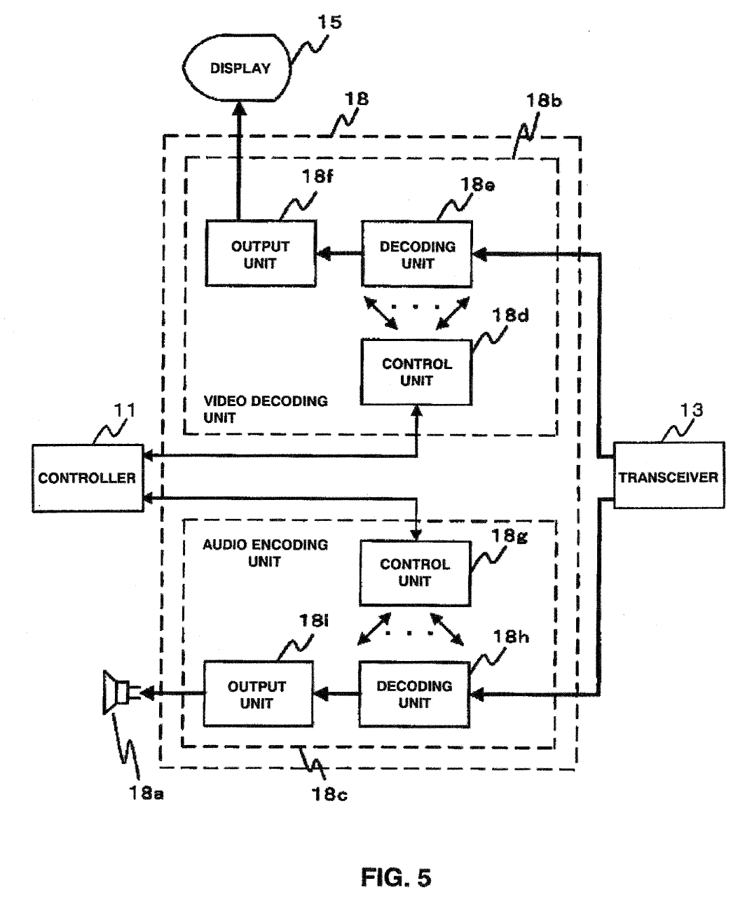

FIG. 5 is a block diagram showing the detailed construction of the decoder 18 of the mobile communication apparatus MSi. The decoder 18 has a video decoding unit 18b and an audio decoding unit 18c. The video decoding unit 18b is connected to the controller 11 and transceiver 13. The video decoding unit 18b includes a video decoding controller 18d for controlling the respective parts of the video decoding unit 18b, a video data decoding unit 18e connected to the transceiver 13 and a video data output unit 18f connected to the display 15.

The audio decoding unit 18c is connected to the controller 11 and transceiver 13, and the audio decoding unit 18c includes an audio decoding controller 18g for controlling the respective parts of the audio decoding unit 18c, an audio data decoding unit 18h connected to the transceiver 13, and an audio data output unit 18i connected to the second speaker 18a.

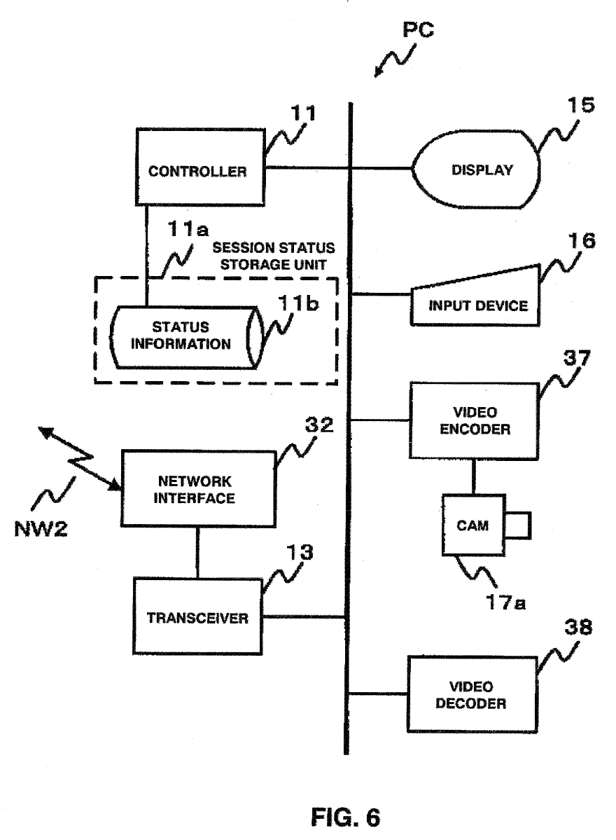

FIG. 6 is a block diagram showing the construction of a personal computer PC. Some of the parts of the personal computer PC are the same as parts of the mobile communication apparatus MSi (more specifically, they perform essentially the same functions as the corresponding parts of the mobile communication apparatus MSi, although there may be some differences). The same parts are represented by the same reference numerals and detailed description thereof is omitted.

The personal computer PC is equipped with a controller 11 for controlling the overall device, a session status storage unit 11a, a network interface 32 connected to the Internet network NW2, a transceiver 13, a display 15, an input device 16, a video encoder 37, a camera 17a, and a video decoder 38. Session status information 11b is stored in the session status storage unit 11a.

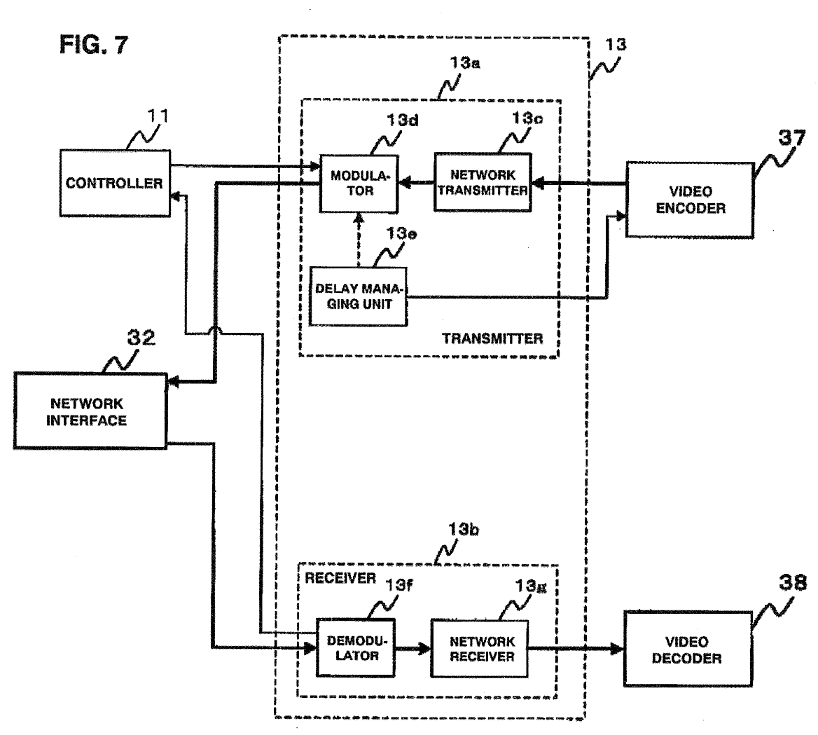

FIG. 7 is a block diagram showing the detailed construction of a transceiver 13 of the personal computer PC. This transceiver 13 is the same as the transceiver 13 of the mobile communication apparatus MSi described above, and the respective parts of the transceiver 13 of the personal computer PC are identified by the same reference numerals as the respective parts of the transceiver 13 of the mobile communication apparatus MSi, and are not described in detail. However, the modulator 13d and demodulator 13f of the personal computer PC are connected to the controller 11, and the modulator 13d and the demodulator 13f are connected to the network interface 32 in place of the radio communication unit 12b. Furthermore, the network transmitter 13c and delay manager 13e of the personal computer PC are connected to the video encoder 37 in place of the encoder 17, and the network receiver 13g of the personal computer PC is connected to the video decoder 38 in place of the decoder 18. And no audio processing unit 14c is provided in the personal computer PC

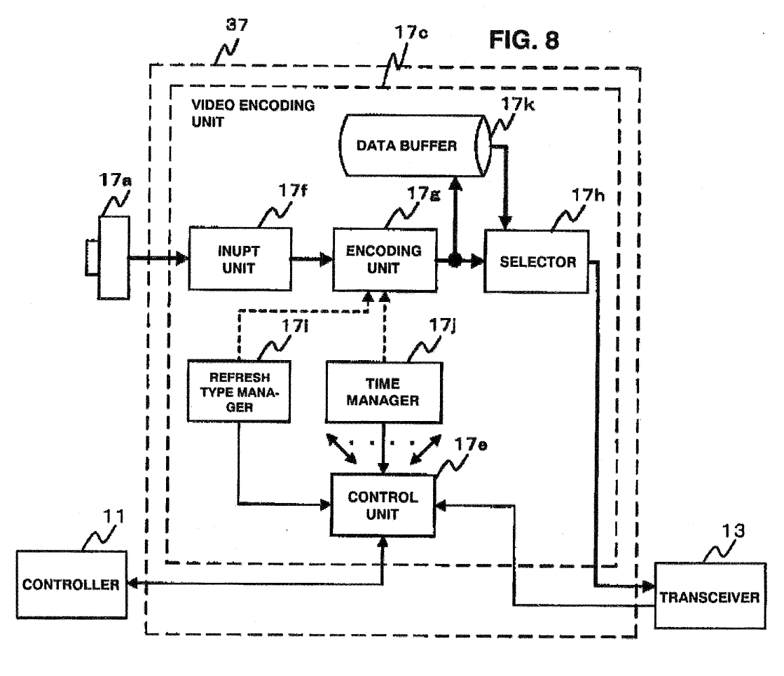

FIG. 8 is a block diagram showing the detailed construction of the video encoder 37. The video encoder 37 is the same in function as the video encoder 17c of the encoder 17 of the mobile communication apparatus MSi described above. Therefore, the same reference numerals are used to represent elements of the video encoder 37, and detailed description thereof is omitted.

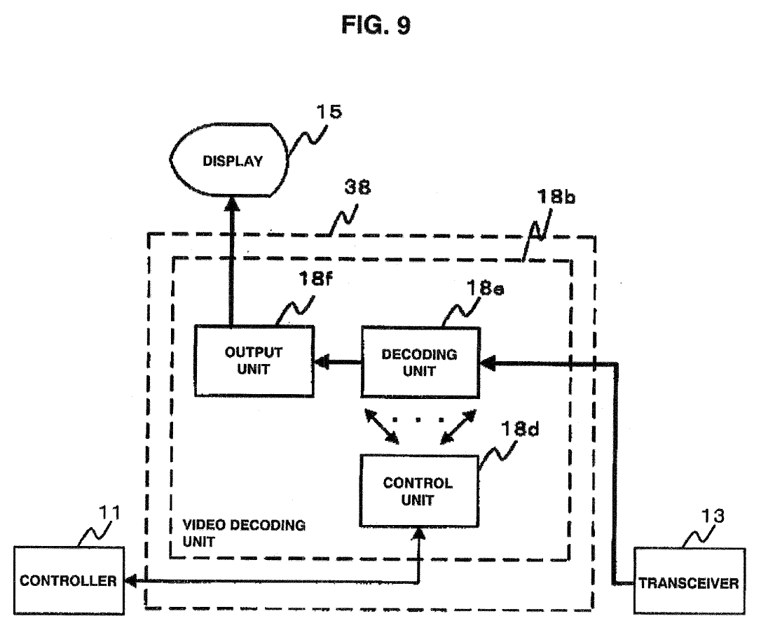

FIG. 9 is a block diagram showing the detailed construction of the video decoder 38. The video decoder 38 is the same in function as the video decoder 18b of the decoder 18 of the mobile communication apparatus MSi described above. Therefore, the same reference numerals are used to represent elements of the video decoder 38, and detailed description thereof is omitted.

The operation of the respective parts of the mobile communication apparatus of the communication system of this embodiment will be described with reference to FIGS. 2 to 5. The radio communication unit 12b transmits to the transceiver 13 a high-frequency signal which is transmitted from a base station of the mobile communication network NW1 and received by the antenna 12a, and transmits a high-frequency signal transmitted from the transceiver 13 to the base station through the antenna 12a. In the transmitter 13a of the transceiver 13, the network transmitter 13c receives video data, which is encoded by the video data encoding unit 17g, from the video data selector 17h of the encoder 17 and audio data encoded by the audio data encoding unit 17o of the encoder 17 to generate packetized video data and packetized audio data from the received encoded video and audio data. In FIG. 3, the direction of two heavy solid-line arrows from the encoder 17 to the network transmitter 13c means that the encoded video data and the encoded audio data are transmitted from the encoder 17.

The modulator 13d executes modulation, frequency-conversion and amplification on the packetized video data and audio data generated by the network transmitter 13c, a control signal transmitted from the controller 11, and the audio data transmitted from the audio processing unit 14c, to obtain a high-frequency signal, and transmits the high-frequency signal to the radio communication unit 12b so as to transmit the high-frequency signal to the base station of the mobile communication network NW1. The transmission destination of the data is based on an instruction from the controller 11 and/or the encoder 17.

The delay managing unit 13e refers to the communication status between the modulator 13d and the radio communication unit 12b, and grasps the transmission band allocated at the transmission time in the communication network NW and the delay time from a transmission request to execution of the transmission when transmitting data. This delay time is obtained by use of RTCP protocol.

In the receiver 13b of the transceiver 13, the demodulator 13f executes amplification, frequency-conversion and demodulation of the high-frequency signal from the radio communication unit 12b, transmits the obtained packetized video data and the packetized audio data to the network receiver 13g if a videophone function is used, transmits a control signal to the controller 11, and transmits the audio data to the audio processing unit 14c if a normal telephone function is used.

The network receiver 13g generates encoded video data and encoded audio data from the packetized video data and the packetized audio data which are obtained by the demodulator 13f. In FIG. 3, the direction of two heavy solid-line arrows from the network receiver 13g to the decoder 18 means that the encoded video data and the encoded audio data are transmitted from the network receiver 13g.

When, in the normal telephone mode, the audio processing unit receives audio data from the demodulator 13f, the audio processing unit 14c decodes the encoded audio data from the transceiver 13 and converts digital audio data which is obtained by decoding the encoded audio data, to analog audio data, amplifies the analog audio data and then transmits the amplified analog audio data to the first speaker 14a.

Furthermore, when audio data is input via the first microphone 14b, the input analog audio data is amplified by the first microphone 14b, converted to digital audio data and encoded into encoded audio data. Then, the audio processing unit 14c transmits the encoded audio data to the transceiver 13.

The display 15, under the control of the controller 11, displays characters, numerals, and video data.

The input device 16 may include, for example, a plurality of numeric keys for inputting a telephone number, name, and so on, and a plurality of function keys for inputting instructions. When a key of the input device 16 is operated, the identifier of the operated key is notified to the controller 11, and an inputted character is displayed on the display 15 under the control of the controller 11.

In the video encoding unit 17c of the encoder 17, the video data input unit 17f receives video data which is captured by the camera 17a, and generates video data which comprises a plurality of still images (frames). The video data encoding unit 17g encodes each frame generated by the video data input unit 17f. This encoding may be performed according to the MPEG method or the H.264 method, for example, however, the present invention is not limited to these methods. The video data encoding unit 17g stores the encoded video data into the data buffer 17k.

The video data encoding unit 17g inserts refresh frames or refresh macro-blocks according to a predetermined timing or rule to remove encoding noise from the video data. According to the refresh system on a frame basis, a frame encoded according to intra-frame coding is generated. Furthermore, according to the refresh method on a macro-block basis, some macro-blocks contained in a plurality of macro-blocks divided from a frame are encoded according to the intra-frame coding. The macro-blocks which are subjected to the intra-frame coding are successively set to different positions among respective frames which are sequential with respect to time.

The video data selector 17h transmits the encoded video data encoded by the video data encoding unit 17g to the transceiver 13. Furthermore, the video data selector 17h reads out designated encoded video data from the data buffer 17k and transmits the encoded video data to the transceiver 13.

The refresh type manager 17i manages which one of the frame-based refresh (hereinafter, “first intra-refresh”) and the macro-block-based refresh (hereinafter, “second intra-refresh”) is used by the video data encoding unit 17g to refresh the video data and reports the refresh type to the video encoding control unit 17e.

The time manager 17j detects the refresh status of the video data executed by the video data encoding unit 17g and reports the status to the video encoding control unit 17e.

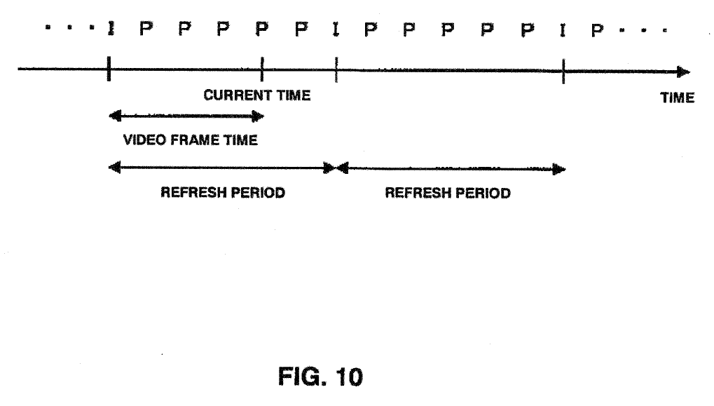

The operation when the video data encoding unit 17g executes the first intra-refresh will be described first with reference to FIG. 10. The time manager 17j detects a refresh period, that is, a time interval at which the video data encoding unit 17g executes the intra-frame coding, and reports the refresh period to the video encoding control unit 17e. Furthermore, the time manager 17j detects the video frame time which indicates the elapsed time from when the previous first intra-refresh was executed.

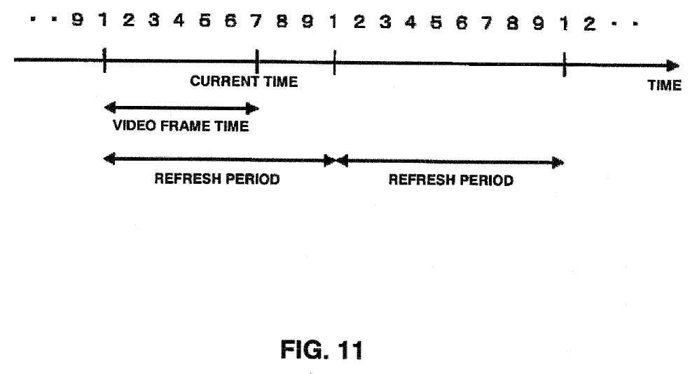

The operation when the video data encoding unit 17g executes the second intra-refresh will be described with reference to FIG. 11. The time manager 17j detects a refresh period, that is, a time interval at which a given macro-block is subjected to the intra-frame coding, (in other words, a time required to subject all the macro-blocks to the intra-frame coding one by one) and reports the refresh period to the video encoding control unit 17e. In the example of FIG. 11, the macro-blocks are grouped into nine groups from a first group to a ninth group, and the macro-blocks of the respective groups are successively subjected to the intra-frame coding over nine frames. In the first encoded frame, the macro-blocks of the first group are assumed to be subjected to intra-frame coding. Furthermore, the time manager 17j detects the video frame time and reports the video frame time to the video encoding control unit 17e. Here, when the second intra-refresh is executed, the video frame time indicates the elapsed time from when the second intra-refresh is executed on the first encoded frame. For example, in FIG. 11, a frame containing the macro-block of the first group corresponds to the first encoded frame.

The audio data input unit 17n receives audio data input via the second microphone 17b, and generates audio data by dividing the audio data into audio frames of a predetermined duration. The audio data encoding unit 17o encodes the audio frames from the audio data input unit 17n according to a given encoding method such as the AAC standard, the AMR standard, or the G.729 standard, and transmits the encoded audio data based on the audio frames to the transceiver 13.

The video data decoding unit 18e of the decoder 18 decodes the encoded video data which is transmitted from the transceiver 13. The video data output unit 18f displays the video data decoded by the video data decoding unit 18e on the display 15. The audio data decoder 18h decodes the encoded audio data transmitted from the transceiver 13. The audio data output unit 18i generates from the speaker 18a the sounds decoded by the audio data decoding unit 18h.

The operation of the respective parts of the personal computer PC will be described with reference to FIGS. 6 to 9. The network interface 32 transmits a high-frequency signal received from the Internet network NW 2 to the transceiver 13, and also transmits a high-frequency signal transmitted from the transceiver 13 to the Internet network NW2. The operation of the transceiver 13 of the personal computer PC is the same as the operation of the transceiver 13 of the mobile communication apparatus MSi described above. However, the transceiver 13 of the personal computer PC does not process audio data transmitted and received over a telephone service or a videophone service. The operation of the video encoder 37 is the same as the operation of the video encoder 17c of the encoder 17 described above. Furthermore, the operation of the video decoder 38 is the same as the operation of the video decoder 18b of the decoder 18 described above.

The operation of switching which communication apparatus is a communication partner for type of information transmitted/received in one communication session is described below with respect to each of the first mobile communication apparatus MS1, the second mobile communication apparatus MS2, and the personal computer PC.

In the following description, there will be described a case where during the videophone communication between the first mobile communication apparatus MS1 and the second mobile communication apparatus MS2, that is, during transmission/reception of video data and audio data therebetween, the second mobile communication apparatus MS2 switches the communication (transmission/reception) of the video data with the first mobile communication apparatus MS1, which is executed by the second mobile communication apparatus MS2 itself, to the communication (transmission/reception) of the video data with the first mobile communication apparatus MS1, which is executed by the personal computer PC.

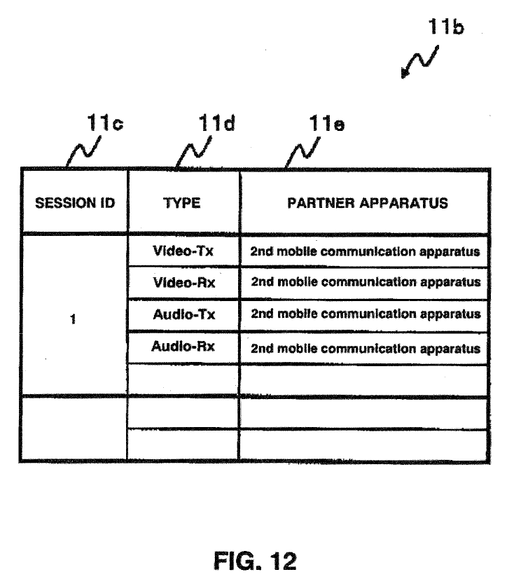

FIG. 12 shows an example of the construction of the session status information 11b. This session status information 11b includes a session identifier 11c, four pairs of communication type information 11d and partner communication apparatus information 11e which are associated with the session identifier 11c. In FIG. 12, the illustration is drawn such that the session identifier 11c, the communication type information 11d and the partner communication apparatus information 11e are stored adjacent to one another. However, this is only an example, and the present invention is not limited to this style.

The session identifier 11c is information for identifying the communication session. The communication type information 11d represents the type(s) of information to be communicated in the communication session identified by the session identifier 11c, and also represents whether the information concerned is transmitted or received. In the example of FIG. 12, the communication session is videophone, and four information pieces representing video transmission (video-Tx), video reception (video-Rx), audio transmission (audio-Tx) and audio reception (video-Rx) are contained in the communication type information 11d. The partner communication apparatus information 11e is information for identifying a communication partner with respect to each communication type 11d.

FIG. 12 shows the session status information 11b of the first mobile communication apparatus MS1 during the videophone communication between the first mobile communication apparatus MS1 and the second mobile communication apparatus MS2. Therefore, the partner communication apparatus information 11e with respect to all the communication types indicates “second mobile communication apparatus”, that is, indicates that the first mobile communication apparatus MS1 is communicating with the second mobile communication apparatus MS2 with respect to all the communication types 11d.

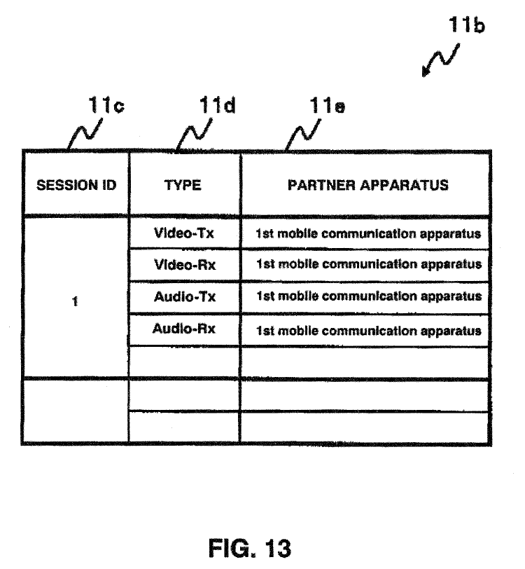

FIG. 13 shows the session status information 11b of the second mobile communication apparatus MS2 during the videophone communication between the first mobile communication apparatus MS1 and the second mobile communication apparatus MS2, and shows that the partner communication apparatus information 11e with respect to all the communication types indicates “first mobile communication apparatus”, that is, indicates that the second mobile communication apparatus MS2 is communicating with the first mobile communication apparatus MS1 with respect to all the communication types.

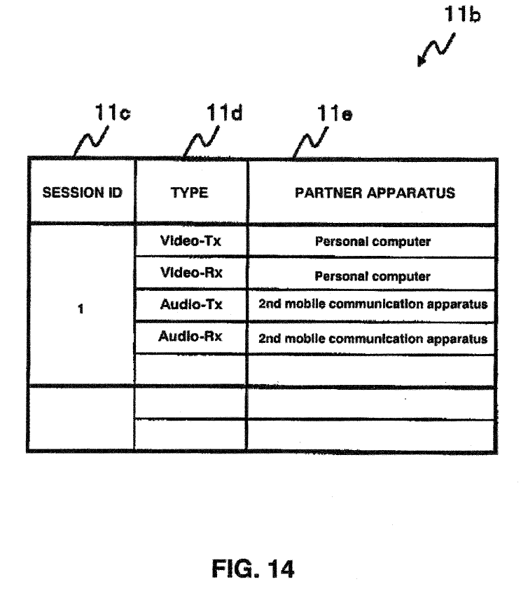

FIG. 14 shows the session status information 11b of the first mobile communication apparatus MS1 after the second mobile communication apparatus MS2 switches the communication (transmission/reception) of video data with the first mobile communication apparatus MS1, which is executed by the second mobile communication apparatus MS2 itself, to the communication (transmission/reception) of the video data with the first mobile communication apparatus MS1, which is executed by the personal computer PC, during the videophone communication between the first mobile communication apparatus MS1 and the second mobile communication apparatus MS2.

That is, in FIG. 14, the partner communication apparatus corresponding to the communication types video transmission and video reception is “personal computer”, and the partner communication apparatus corresponding to the communication types audio transmission and audio reception is “second mobile communication apparatus”. Accordingly, the communication type information 11d and the partner communication apparatus information 11 indicate that the first mobile communication apparatus MS1 transmits/receives video data to/from the personal computer PC and transmits/receives audio data to/from the second mobile communication apparatus MS2.

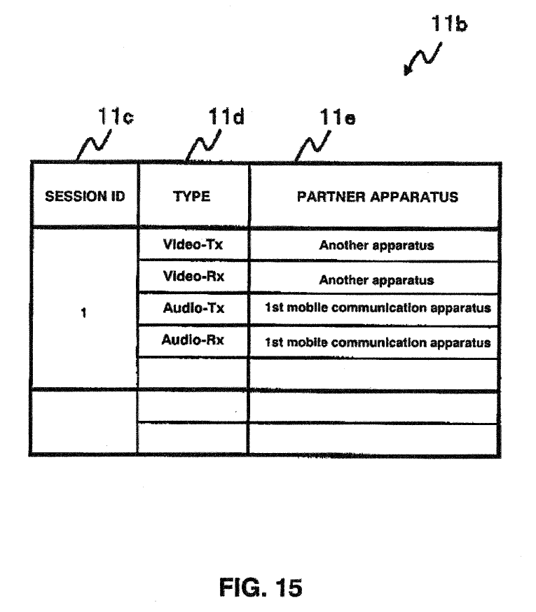

FIG. 15 shows the session status information 11b of the second mobile communication apparatus MS2 after the switching. That is, the partner communication apparatus corresponding to the communication types video transmission and video reception is “another apparatus” (in other words, the partner communication apparatus information 11e indicates that another apparatus performs the video transmission and reception), and the partner communication apparatus corresponding to the communication type types audio transmission and audio reception is “first mobile communication apparatus”. Accordingly, the communication type information 11d and the partner communication apparatus information 11 indicate that the second mobile communication apparatus MS2 transmits/receives audio data to/from the first mobile communication apparatus MS1 without transmitting/receiving any video data.

Here, the second mobile communication apparatus MS2 does not transmit/receive video data to/from any apparatus, however, the partner communication apparatus information 11e corresponding to the communication types video transmission and video reception is “another apparatus”. Therefore, it is indicated that the first mobile communication apparatus MS1, to/from which the second mobile communication apparatus MS2 transmits/receives audio data, transmits/receives video data with an apparatus (in this case, the personal computer PC) other than the second mobile communication apparatus MS2.

If the first mobile communication apparatus MS1 does not transmit/receive any video data, that is, if the communication session identified by the session identifier 11c is only the transmission/reception of audio data between the first mobile communication apparatus MS1 and the second mobile communication apparatus MS2, no information is stored in the session status information 11b of the second mobile communication apparatus MS2 in the partner communication apparatus information 11e corresponding to the communication types video transmission and video reception.

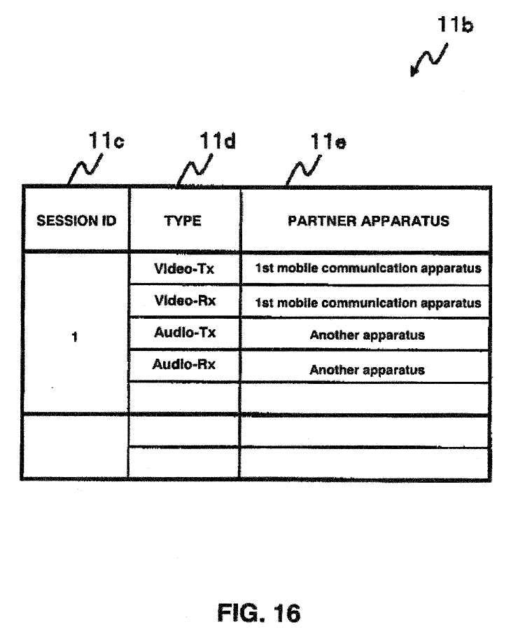

FIG. 16 shows the session status information 11b of the personal computer PC after the switching. That is, the partner communication apparatus corresponding to the communication types video transmission and video reception is “first mobile communication apparatus”, and the partner communication apparatus corresponding to the communication types audio transmission and audio reception is “another apparatus”. Accordingly, the communication type information 11d and the partner communication apparatus information 11e indicate that the personal computer PC transmits/receives video data with the first mobile communication apparatus MS1, and does not transmit/receive any audio data.

Here, the partner communication apparatus corresponding to the communication types audio transmission and audio reception is “another apparatus”, and thus the personal computer PC does not transmit/receive any audio data. Instead, as described above, it is indicated that the first mobile communication apparatus MS1, to/from which the personal computer PC transmits/receives video data, transmits/receives audio data with an apparatus (in this example, the second mobile communication apparatus MS2) other than the personal computer PC.

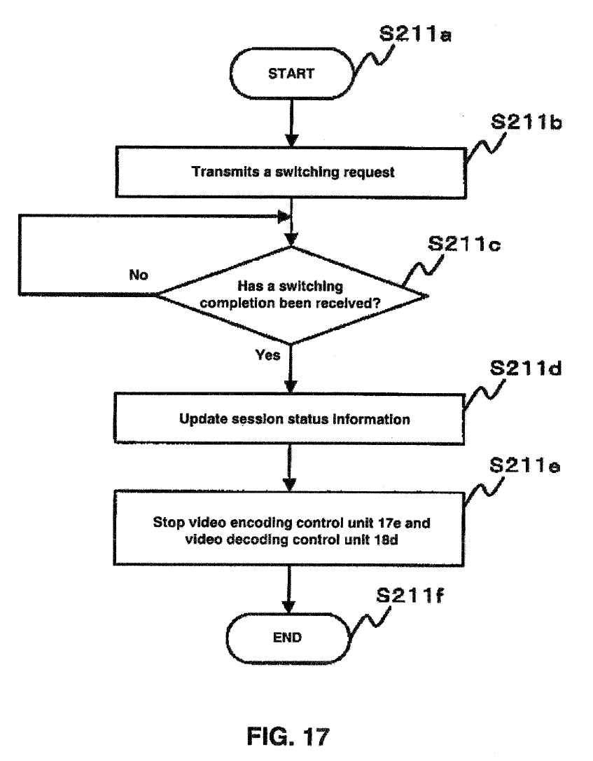

FIG. 17 is a flowchart showing the control operation of the controller 11 of the second mobile communication apparatus MS2 when the second mobile communication apparatus MS2 switches the transmission/reception of video data with the first mobile communication apparatus MS1 which is executed by the second mobile communication apparatus MS2 to the transmission/reception of the video data with the first mobile communication apparatus MS1, which is executed by the personal computer PC during the videophone communication between the first mobile communication apparatus MS1 and the second mobile communication apparatus MS2.

Upon a predetermined key operation of the input device 16 of the second mobile communication apparatus MS2 during videophone communication with the first mobile communication apparatus MS1, the controller 11 of the second mobile communication apparatus MS2 starts the operation of switching the transmission/reception of video data to/from the first mobile communication apparatus MS1 to the transmission/reception between the first mobile communication apparatus MS1 and the personal computer PC. Here, the controller 11 of the second mobile communication apparatus MS2 obtains information identifying the personal computer PC required to perform the communication with the personal computer PC by a predetermined key operation of the input device 16 of the second mobile communication apparatus MS2 (step S211a).

In the following description, when the operation of the controller 11 of the second mobile communication apparatus MS2 is described with reference to FIG. 17, the respective parts identified, such as the controller 11, etc., indicate the respective parts of the second mobile communication apparatus MS2 if not otherwise specified.

Subsequently, the controller 11 transmits the switching request to the first mobile communication apparatus MS1 by using the information identifying the personal computer PC as a parameter (step S211b), and in response to the request, it is judged whether a switching completion notification is received from the first mobile communication apparatus MS1 (step S211c). When the notification is not received once a predetermined time elapses, the controller 11 repeats the judging operation of the step S211c.

If, however, the switching completion request is received, the controller 11 updates the session status information 11b so that the session status information 11b represents the completion of the switching (step S211d). That is, before the switching, the session status information 11b represents that the second mobile communication apparatus MS2 transmits/receives video data and audio data to/from the first mobile communication apparatus MS1 as shown in FIG. 13. After the switching, the session status information 11b is updated so that the second mobile communication apparatus MS2 transmits/receives the audio data to/from the first mobile communication apparatus MS1, and another apparatus other than the second mobile communication apparatus MS2 transmits/receives the video data with the first mobile communication apparatus MS1, as shown in FIG. 15.

Subsequently, the controller 11 controls the video encoding control unit 17e and the video decoding control unit 18d to stop the operation of the video encoder 17c and the operation of the video decoder 18b (step S211e), and the controller 11 finishes the switching control operation (step S211f).

When the operation of step S211e is performed, the controller 11 may stop the encoding by the video encoder 17c and the transmission operation of video data to the first mobile communication apparatus MS1 after these operations are continued for a predetermined time. Furthermore, the receiving and decoding operation of video data from the first mobile communication apparatus MS1 by the video decoding unit 18b may be continued until the transceiver 13 no longer receives video data transmitted from the first mobile communication apparatus MS1, and stopped when a predetermined time elapses after the transceiver 13 receives no video data.

By continuing the operations of the video encoder 17c and the video decoding unit 18b over this predetermined time, the second mobile communication apparatus MS2 can continue to transmit/receive video data until the personal computer PC transmits/receives video data. This prevents a user from being left without a picture at any point during the switch, thereby preventing the user from feeling discomfort.

The controller 11 may transmit to the personal computer PC a (still) picture displayed on the display 15 or received encoded video data stored in a video data buffer (not shown) in the video decoding unit 18b before or in parallel to the communication by the personal computer PC with the first mobile communication apparatus MS1, and the picture or the video data is displayed on the display 15 of the personal computer PC. In this way, the user can be prevented from feeling discomfort due to no picture being displayed on both of the display 15 of the second mobile communication apparatus MS2 and the display 15 of the personal computer PC.

Also, the controller 11 may transmit video data which is encoded video data stored in the data buffer 17k and just previously subjected to intra-frame coding, and encoded video data (which are plural encoded video data and thus are moving pictures) displayed subsequently to the above video data.

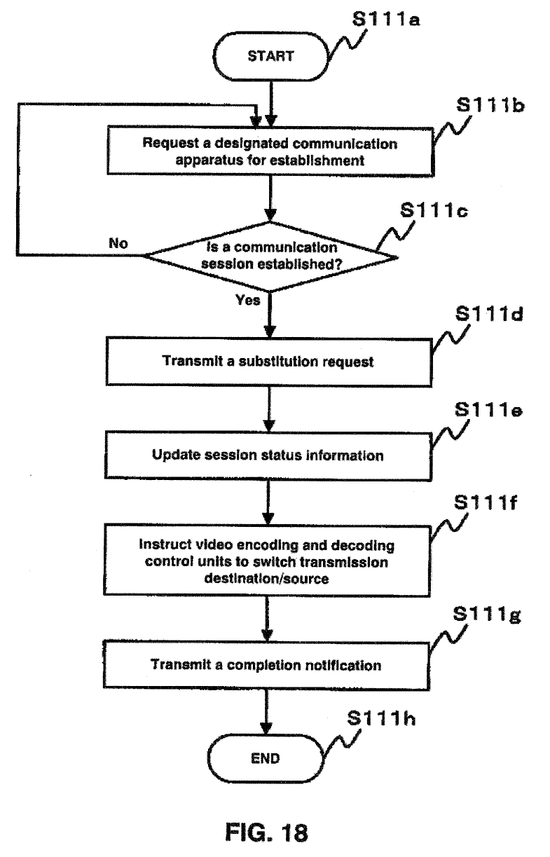

FIG. 18 is a flowchart showing the control operation of the controller 11 of the first mobile communication apparatus MS1 when the second mobile communication apparatus MS2 switches the transmission/reception of video data with the first mobile communication apparatus, which is executed by the second mobile communication apparatus MS2 itself, to the transmission/reception of the video data with the first mobile communication apparatus MS1, which is executed by the personal computer PC during the videophone communication between the first mobile communication apparatus MS1 and the second mobile communication apparatus MS2.

The controller 11 of the first mobile communication apparatus MS1 receives the switching request, which is transmitted from the second mobile communication apparatus MS2 and contains information identifying the personal computer PC as a parameter, and starts the operation of switching the transmission/reception of video data to/from the second mobile communication apparatus MS2 to the transmission/reception to/from the personal computer PC (step S111a). In the following description, when the operation of the controller 11 of the first mobile communication apparatus MS1 is described with reference to FIG. 18, the respective parts identified, such as the controller 11, etc., indicate the respective parts of the first mobile communication apparatus MS1 if not otherwise specified.

Subsequently, the controller 11 issues a request to a communication apparatus as a switching destination for establishment of a communication session (in this case, the personal computer PC) (step S111b), and judges whether the communication session is established with the destination communication apparatus (step S111c). If the communication session is not established over a predetermined time, the controller 11 returns to step S111b.

When the personal computer PC is connected to the mobile communication network NW1, the information for identifying the personal computer PC is the telephone number of the personal computer, for example. When the personal computer PC is connected to the Internet network NW2, the information identifying the personal computer PC is an IP address of the personal computer PC, for example.

When the first mobile communication apparatus MS1 is connected to the mobile communication network NW1 and the personal computer PC is connected to the Internet network NW2, the controller 11 carries out the request operation via a gateway (not shown) connected to both the mobile communication network NW1 and the Internet network NW2 by using the information identifying the personal computer PC as a parameter.

On the other hand, when a communication session is established in step S111c, the controller 11 transmits a substitution request for exchanging video data in place of the second mobile communication apparatus MS2 to the personal computer PC. That is, it is transmitted that the transmission/reception of video data is carried out between the first mobile communication apparatus MS1 and the personal computer PC (step S111d). Then, the session status information 11b is updated so as to represent the completion of the switching (step S111e).

That is, before the switching, the session status information 11b indicates that the first mobile communication apparatus MS1 transmits/receives video data and audio data to/from the second mobile communication apparatus MS2 as shown in FIG. 12. However, after the switching, the session status information 11b is updated so as to indicate the condition that the first mobile communication apparatus MS1 is transmitting/receiving audio data to/from the second mobile communication apparatus MS2, and is transmitting/receiving video data to/from the personal computer PC, as shown in FIG. 14.

When the communication session is established, two communication sessions are connected to the second mobile communication apparatus MS2 and the personal computer PC respectively, and the controller 11 manages different sessions based on the respective communication sessions.

Subsequently, the controller 11 controls the video encoding control unit 17e so that the transmission destination of the video data encoded by the video encoding unit 17c is switched to the personal computer PC. Furthermore, the controller 11 controls the video decoding control unit 18d so that the transmission source of the encoded video data to be received by the video encoding unit 18b is switched to the personal computer PC (step S111f).

After the video data whose transmission destination is switched by the personal computer PC is transmitted to the communication network NW, or after a predetermined time elapses from the transmission of the video data concerned to the communication network NW, the controller 11 transmits the switching completion notification to the second mobile communication apparatus (step S111g), and then finishes the control operation (step S111h).

The operations of the video encoding control unit 17e and the video decoding control unit 18d controlled by the controller 11 shown in the step S111f will be described. The video encoding control unit 17e executes the following operation so that the video data encoded by the video encoding unit 17c is displayed on the display 15 of the personal computer PC after a short lapse time, and the time for which the video data is displayed on neither the display 15 of the second mobile communication apparatus MS2 nor the display 15 of the personal computer PC is shortened. This operation prevents a user using the second mobile communication apparatus MS2 and the personal computer PC from feeling discomfort during the switching time.

The video encoding control unit 17e of the first mobile communication apparatus MS1 judges on the basis of a notification from the refresh type manager 17i whether the video data encoded by the video data encoder 17g is subjected to the first intra-refresh or the second intra-refresh. When it is judged that it is the first intra-refresh, any one of the following four operations is executed. These four operations are not necessarily excluded from one another, and non-exclusive plural operations may be executed.

In the first operation, the video encoding control unit 17e controls the video data selector 17h over a predetermined time so that video data is transmitted through the transceiver 13 to both the second mobile communication apparatus MS2 and the personal computer PC. When the encoding formats of video data to be transmitted to these devices are different from each other, the video data encoding unit 17g is further controlled to generate differently encoded video data to be transmitted to the respective apparatuses.

On the basis of a notification from the delay manager 13e, the predetermined time (during which the video data is still transmitted to the second mobile communication apparatus MS2) is determined as follows. A delay time which is associated with the communication with the second mobile communication apparatus MS2 and the communication with the personal computer PC is obtained, and the predetermined time is determined from the delay time.

According to the first operation, there is no time for which video data is displayed on neither the display 15 of the second mobile communication apparatus MS2 nor the display 15 of the personal computer PC. The first operation is executed when it is judged on the basis of the notification from the delay manager 13e that the transmission band has an allowance. Furthermore, when video data to be transmitted to the respective apparatuses are different, the first operation would be carried out if it is judged that the video data encoding unit 17g is capable of performing two kinds of encoding.

In the second operation, the video encoding control unit 17e controls the video data encoding unit 17g to execute the first intra-refresh to be next encoded. According to this second operation, the personal computer PC can immediately make a stable display on the display 15. That is, when inter-coded video data is received before intra-coded video data is received, the inter-coded video data cannot be normally displayed. However, with the second operation, since intra-coded data is received first by the personal computer PC, the display start is never delayed, nor is there any instability in the displayed data.

The video encoding control unit 17e executes the second operation when it is judged on the basis of the notification from the delay manager 13e that the transmission band has an allowance. This is because the intra-coded video data have a larger number of bits than the inter-coded video data.

On the other hand, if it is judged that the transmission band has no allowance, the video encoding control unit 17e controls the video data encoding unit 17g so that no frame is encoded until a frame to be next subjected to intra-coding comes.

This is because even if these frames are subjected to inter-coding, the personal computer PC cannot normally display the video data of these encoded frames, and thus the encoding itself is unnecessary. Furthermore, the above processing brings an effect that the load of the video data encoding unit 17g can be reduced and congestion of the communication network NW can be prevented.

In the third operation, the video encoding control unit 17e controls the video data selector 17h so that the encoded video data stored in the data buffer 17k, that is, the encoded video data which has been transmitted to the second mobile communication apparatus MS2 and just previously subjected to intra-coding, is transmitted to the personal computer PC through the transceiver 13. Furthermore, the video data (subjected to inter-coding) subsequent to the above video data are transmitted to the personal computer PC through the transceiver 13.

The video encoding control unit 17e executes this third operation when it receives from the video frame time manager 17j the notification of the video frame time and the refresh period when the video encoding control unit 17e is subjected to the control shown in the step S111f from the controller 11 and the third operation is judged as being proper on the basis of these values.

That is, when the quotient obtained by dividing the video frame time by the refresh period is smaller than a predetermined value (near to zero), the video encoding control unit 17e executes the third operation. The reason is as follows. When the quotient is small, video data which is not very old is transmitted, the time difference from newly encoded video data to be transmitted is small, the personal computer PC can continue to display smoothly and provide no discomfort to the user. However, when the quotient is large (near to 1), the time difference is large and it is difficult to continue to display smoothly regardless of a large amount of data to be transmitted.

When only the video data which was just previously subjected to intra-coding is transmitted to the personal computer PC, the above predetermined value is not important. This is because in the case of transmission of only one encoded video data encoded according to intra-coding, the data amount to be transmitted is almost constant despite the predetermined value being large. In the case of transmission of only one encoded video data encoded according to intra-coding, there is a probability that the personal computer PC may not be able to continue to display smoothly, however, the discomfort which the user feels can be reduced.

In the fourth operation, the video encoding control unit 17e requests the controller 11 to set a predetermined standby time until the switching completion notification is transmitted to the second mobile communication apparatus MS2 in step S111g after the control of the video encoding control unit 17e and the video decoding control unit 18d in step S111f. By the fourth operation, the second mobile communication apparatus MS2 continues to transmit/receive video data to/from the first mobile communication apparatus MS1 for the predetermined standby time. Therefore, the first mobile communication apparatus MS1 and the second mobile communication apparatus MS2 continue to display pictures on the displays 15, so that the users of the apparatuses do not feel discomfort.

When it is judged on the basis of the notification from the refresh type manager 17i that the video data encoding unit 17g executes the second intra-refresh, the video encoding control unit 17e executes an operation similar to when the first intra-refresh is executed, however, it is different in the following points.

More specifically, in the second operation, the video encoding control unit 17e controls the video data encoding unit 17g to shorten the refresh period at least until all the macro-blocks are subjected to intra-coding. In other words, when each frame is encoded, a larger number of macro-blocks are subjected to intra-coding.

Here, the video encoding control unit 17e controls the video data encoding unit 17g to reset the video frame time, that is, set the video frame time to zero irrespective of the video frame time at that time, and in the next encoded frame and subsequent frames, and set macro-blocks to be subjected to intra-coding so that different portions of the frame are selected in a predetermined order. However, the present invention is not limited to this style. For example, the video frame time may not be reset, and a larger number of macro-blocks may be subjected to intra-coding while keeping the order of the macro-blocks which are scheduled to be intra-coded in the frames to be next and subsequently encoded.

Furthermore, when the video frame time cannot be reset and the refresh period can be changed at only the timing at which the video frame time is equal to zero, the video encoding control unit 17e controls the video data encoding unit 17g to continue the encoding without changing the refresh period and shorten the refresh period at the time point when the video frame time is next equal to zero.

Alternatively, the video encoding control unit 17e may control the video data encoding unit 17g to temporarily finish the encoding operation, indicate a new short refresh period and then start encoding. Or, when the quotient obtained by dividing the video frame time by the refresh period is large (near to 1), the refresh period is shortened when the video frame time is next equal to zero. When the quotient is small (near to zero), the encoding is freshly started. When the quotient is large, the encoding based on the short refresh period is started soon, and thus the effect due to occurrence of a load of freshly starting the encoding is low.

Furthermore, the video encoding control unit 17e controls the video data encoding unit 17g to make the refresh period as short as possible. That is, in at least one frame, all of the macro-blocks may be subjected to intra-coding. The operation of subjecting all of the macro-blocks to intra-coding is consequently the same as the second operation when it is judged that the first intra-refresh is executed, that is, the operation of intra-coding the frame to be next encoded.

Still further, in the third operation, the probability that no intra-coded video data is contained in the encoded video data stored in the data buffer 17k is high, and thus the video encoding control unit 17e controls the video data selector 17h so that encoded video data which is stored in the data buffer 17k and which corresponds to a predetermined amount of video data encoded just previously is transmitted to the personal computer PC through the transceiver 13 in the encoding order. The predetermined amount is not required to exceed the number of groups of the macro-blocks which correspond to the video frame period as described with reference to FIG. 11.

Moreover, the video decoding control unit 18d of the first mobile communication apparatus MS1 executes the following operation so as to shorten the time for which neither video data transmitted from the second mobile communication apparatus MS2 nor video data transmitted from the personal computer PC is displayed on the display 15. This operation is to prevent the user of the first mobile communication apparatus MS1 from feeling discomfort when the switching is carried out.

The video decoding control unit 18d controls the video data decoding unit 18e to decode encoded video data transmitted from the second mobile communication apparatus MS2 until encoded video data transmitted from the personal computer PC is passed through the transceiver 13 and received.

When the encoded video data transmitted from the personal computer PC is received through the transceiver 13, the video decoding control unit 18d controls the video data decoding unit 18e to decode the encoded video data from the personal computer PC. On the other hand, decoding processing on the encoded video data transmitted from the second mobile communication apparatus MS2 is stopped when the decoding processing on the encoded video data from the personal computer PC is initiated. Also, if the encoded video data from the second mobile communication apparatus MS2 exists in the video data decoding unit 18e at the time the decoding processing on the encoded video data from the personal computer PC is initiated, the encoded video data from the second mobile communication apparatus MS2 is deleted.

Furthermore, when both the encoded video data transmitted from the personal computer PC and the encoded video data transmitted from the second mobile communication apparatus MS2 are not received, the video decoding control unit 18d controls the video data output unit 18f to continue to display the picture which was last decoded and displayed on the display 15.

In the description with reference to FIG. 18, the controller 11 transmits the switching completion notification to the second mobile communication apparatus MS2 in step S111g after instructing the transmission/reception of video data to/from the personal computer PC in step S111f. Therefore, during this time period, the transmission/reception of the encoded video data can be executed through two communication sessions based on the connection to the second mobile communication apparatus MS2 and the connection to the personal computer PC.

When the transmission of the video data by the two communication sessions is not permitted due to constraint of the communication network NW or constraint of the transceiver 13, the controller 11 transmits the switching completion to the second mobile communication apparatus MS2 after the communication session to the personal computer PC is connected and before encoded video data is transmitted to the personal computer PC, and breaks the session for the transmission/reception of video data to/from the second mobile communication apparatus MS2.

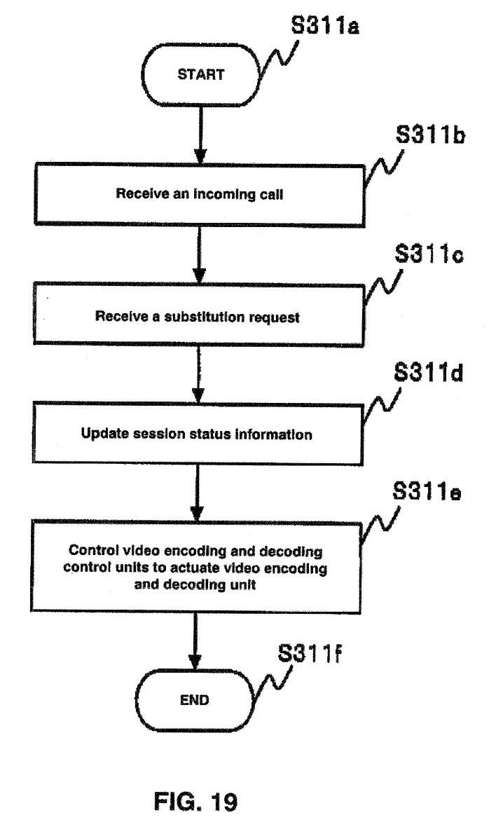

FIG. 19 is a flowchart of the control operation of the controller 11 of the personal computer PC when the second mobile communication apparatus MS2 switches the transmission/reception of video data to/from the first mobile communication apparatus MS1 which is executed by the second mobile communication apparatus MS2 itself to the transmission/reception of the video data t/from the first mobile communication apparatus MS1 which is executed by the personal computer PC during the videophone communication between the first mobile communication device MS1 and the second mobile communication apparatus MS2.

The controller 11 of the personal computer PC receives an incoming call signal from the first mobile communication apparatus MS1, and starts the operation of transmitting/receiving video data to/from the first mobile communication apparatus MS1 (step S311a). In the following description, in which the operation of the controller 11 of the personal computer PC is described with reference to FIG. 19, the respective parts identified, such as the controller 11, etc., indicate the respective parts of the personal computer PC if not otherwise specified.

Subsequently, the controller 11 executes processing on the incoming call signal to connect the communication session (step S311b), and receives the substitution request transmitted from the first mobile communication apparatus MS1 (step S311c). Then, the controller 11 updates the session status information 11b to indicate the switching completion status (step S311d). That is, no information is stored before the switching, however, after the switching, as shown in FIG. 16, the transmission/reception of video data to/from the first mobile communication apparatus MS1 is carried out, and the session status is renewed so as to indicate the condition that the first mobile communication apparatus MS1 transmits/receives audio data to/from a device other than the personal computer PC.

The controller 11 controls the video encoding control unit 17e to activate the video encoding unit 17c, further controls the video decoding control unit 18d to activate the video decoding unit 18b (step S311e), and then finishes the control operation (step S311f).

The video decoding control unit 18d controls the video decoding unit 18b so that, when the encoded video data according to the first intra-refresh is received, inter-coded video data received before intra-coded video data is not decoded.

Furthermore, when encoded video data according to the second intra-refresh is received, inter-coded data which is received before intra-coded data is received is not decoded with respect to each macro-block. Or, the video data output unit 18f is controlled not to transmit the decoded video data until intra-coded data is received with respect to all the macro-blocks is received. This is to prevent unstable display or partial display on the display 15.

The controller 11 receives video data (still pictures or moving pictures) from the second mobile communication apparatus MS2 before the communication with the first mobile communication apparatus MS1, and displays the video data on the display 15. The display may be continued until encoded video data is received from the first mobile communication apparatus MS1. According to this method, the user may be prevented from feeling discomfort because no picture is displayed on the display 15 of the second mobile communication apparatus MS2 or the display 15 of the personal computer PC.

The operation of switching the partner communication apparatus for each type of information transmitted/received in one communication session described above may be executed for any communication type 11d, that is, every type of transmitted/received information. As another example, the operation of switching the transmission/reception of video data to transmission/reception of video data between the first mobile communication apparatus MS1 and the second mobile communication apparatus MS2 during the videophone communication in which the first mobile communication apparatus MS1 and the second mobile communication apparatus MS2 transmit/receive audio data to each other and the first mobile communication apparatus MS1 and the personal computer PC transmit/receive video data to each other will be described.

This operation is started upon a request from the second mobile communication apparatus MS2 or a request from the personal computer PC. In this case, it is assumed that the operation is started upon a request from the second mobile communication apparatus MS2.

First, the switching operation of the controller 11 of the second mobile communication apparatus MS2 will be described. In the description below of the operation of the controller 11 of the second mobile communication apparatus MS2, the respective parts identified, such as the controller 11, etc., indicate the respective parts of the second mobile communication apparatus MS2 if not otherwise specified.

The controller 11 starts the switching operation by a predetermined key operation of the input device 16 of the second mobile communication apparatus MS2. Further, it refers to the session status information 11b (at this time, the information shown in FIG. 15 is stored) to obtain information indicating that video data is transmitted/received between the first mobile communication apparatus and an apparatus other than the second mobile communication apparatus MS2, judges that the switching operation can be performed, and continues the operation.

Subsequently, the controller 11 transmits the switching request to the first mobile communication apparatus MS1, and judges whether a switching completion notification to the request is received from the first mobile communication apparatus MS1. If the switching completion notification is received, the controller 11 renews the session status information 11b so as to indicate the condition that the switching is completed, that is, updates the session status information 11b to the information shown in FIG. 13. Furthermore, the controller 11 controls the video encoding control unit 17e and the video decoding control unit 18d to start the operation of the video encoding unit 17c and the operation of the video decoding unit 18b, respectively.

The operation of the controller 11 is essentially the same as the operation of the controller 11 when the second mobile communication apparatus MS2 switches the transmission/reception of the video data to/from the first mobile communication apparatus MS1 during the videophone communication between the first mobile communication apparatus MS1 and the second mobile communication apparatus MS2 described with reference to FIG. 17, which is executed by the second mobile communication apparatus MS2 itself, to the transmission/reception of the video data with the first mobile communication apparatus MS1, which is executed by the personal computer PC.

Next, the switching operation of the controller 11 of the first mobile communication apparatus MS1 will be described. In the following description of the operation of the controller 11 of the first mobile communication apparatus MS1, the respective parts identified, such as the controller 11, etc., indicate the respective parts of the first mobile communication apparatus MS1 if not otherwise specified.

The controller 11 of the first mobile communication apparatus MS1 receives the switching request transmitted from the second mobile communication apparatus MS2 and starts the switching operation. Further, the controller 11 refers to the session status information 11b (at this time, information shown in FIG. 14 is stored) to obtain information indicating that the video data is transmitted/received to/from the personal computer PC, judges that the switching operation can be performed, and continues the operation.

Subsequently, the controller 11 renews the session status information 11b so as to indicate the condition that the switching is completed, that is, updates the session status to the information shown in FIG. 12. The controller 11 controls the video encoding control unit 17e so that the transmission destination of the video data encoded by the video encoding unit 17c is switched to the second mobile communication apparatus MS2. Furthermore, the controller 11 controls the video decoding control unit 18d so that the transmission source of the encoded video data to be received by the video decoding unit 18b is switched to the second mobile communication apparatus MS2. Furthermore, the notification of the switching completion is transmitted to the second mobile communication apparatus MS2, and the call with the personal computer PC is disconnected.

The operation of the controller 11 is essentially the same as the operation of the controller 11 when the second mobile communication apparatus MS2 switches the transmission/reception of video data to/from the first mobile communication apparatus MS1, which is executed by the second mobile communication apparatus MS2 itself, to the transmission/reception of the video data with the first mobile communication apparatus MS1, which is executed by the personal computer PC during the videophone communication between the first mobile communication apparatus MS1 and the second mobile communication terminal MS2 described with reference to FIG. 18. The primary difference resides in that the communication session with the personal computer PC is disconnected in place of the connection of the communication session with the personal computer PC.

Next, the switching operation of the controller 11 of the personal computer PC will be described. In the following description of the operation of the controller 11 of the personal computer PC, the respective parts identified, such as the controller 11, etc., indicate the respective parts of the personal computer PC if not otherwise specified.

The controller 11 of the personal computer PC receives the disconnection of the communication session transmitted from the first mobile communication apparatus MS1, and starts the switching operation. The controller 11 refers to the session status information 11b (at this time, information shown in FIG. 16 is stored) to obtain information indicating that the communication executed by the personal computer PC is the transmission/reception of video data to/from the first mobile communication apparatus MS1, judges on the basis of the disconnection of the communication session that the personal computer PC gets out of the session having the session identifier 11c of “1”, and continues the operation.

Subsequently, the controller 11 updates the session status information by deleting all the information associated with the session having the session identifier 11c of “1”. Furthermore, the controller 11 controls the video encoding control unit 17e and the video decoding control unit 18d to stop the operation of the video encoding unit 17c and the operation of the video decoding unit 18b.

The operation of the controller 11 is the same as the operation of the controller 11 when the second mobile communication apparatus MS2 switches the transmission/reception of video data to/from the first mobile communication apparatus MS1, which is executed by the second mobile communication apparatus MS2 itself, to the transmission/reception of the video data with the first mobile communication apparatus MS1, which is executed by the personal computer PC during the videophone communication between the first mobile communication apparatus MS1 and the second mobile communication terminal MS2 described with reference to FIG. 19. The primary difference is that the communication session is disconnected in place of the incoming call

Next, the operation of finishing the communication session of the videophone communication in which the first mobile communication apparatus MS1 and the second mobile communication apparatus MS2 transmit/receive audio data to each other, and the first mobile communication terminal MS1 and the personal computer PC transmit/receive video data to each other will be described.

The communication session finishing operation may be started from any apparatus in the communication session (any of the first mobile communication apparatus MS1, the second mobile communication apparatus MS2 and the personal computer PC). The operation is started by a predetermined operation key of the input device 16 of any apparatus in the communication session, and the controller 11 of the apparatus controls the video encoding control unit 17e, the video decoding control unit 18d, the audio encoding control unit 17m and the audio decoding control unit 18g of the apparatus to stop all the video data transmission/reception and the audio data transmission/reception which are executed by the apparatus. Furthermore, the controller 11 refers to the session status information 11b, notifies the end of the communication session to an apparatus with which the apparatus communicates by videophone communication, and then disconnects the communication session associated with the videophone communication. Furthermore, the controller 11 updates the session status information 11b by deleting all of the information associated with the communication session of the videophone communication.

An apparatus which receives the notification of the end of the communication session from another apparatus controls the video encoding control unit 17e, the video decoding control unit 18d, the audio encoding control unit 17m and the audio decoding control unit 18g of the apparatus to stop all the video data transmission/reception and the audio data transmission/reception which are executed by the apparatus. Then, it refers to the session status information 11b, notifies the end of the communication session to an apparatus with which the apparatus communicates by the videophone communication and is an apparatus other than the apparatus which notified of the end of the communication session, and then disconnects the communication session associated with the videophone communication. Furthermore, the session status information 11b is updated by deleting the information associated with the communication session of the videophone communication.

In the foregoing description, the present invention is applied to the mobile communication apparatus MSi and the personal computer PC. However, the present invention is not limited to these apparatuses. Furthermore, the personal computer PC does not transmit/receive audio data, however, the present invention may be applied to an apparatus which can transmit or receive at least any one kind of data. For example, the present invention may be applied to a television receiver which is not capable of transmitting video data or audio data.

In the foregoing description, the second mobile communication apparatus MS2 switches the transmission/reception of video data to/from the first mobile communication apparatus MS1, which is executed by the second mobile communication apparatus MS2 itself, to the transmission/reception of the video data with the first mobile communication apparatus MS1, which is executed by the personal computer PC during the videophone communication between the first mobile communication apparatus MS1 and the second mobile communication terminal MS2. Furthermore, after the above operation, a switching operation may be carried out such that that the transmission/reception of video data may be executed between the first mobile communication apparatus MS1 and the second mobile communication apparatus MS2 again.

However, the present invention is not limited to the above description. That is, any number of four communication types indicated by the communication type information 11d may be switched to a different apparatus. Furthermore, some of the four communication types indicated by the communication type information 11d may be switched to a different apparatus in not only the communication executed by the second mobile communication apparatus MS2, but also the communication executed by the first mobile communication apparatus MS1.

When the transmission/reception of video data which is executed by the first mobile communication apparatus MS1 is switched to a third mobile communication apparatus (not shown) after the switching used in the forgoing description, the video data is transmitted/received between the third mobile communication apparatus and the personal computer PC, and the audio data is transmitted/received between the first mobile communication apparatus MS1 and the second mobile communication apparatus MS2, so that there is no apparatus which participates in transmission/reception of both the video data and the audio data.

Therefore, with respect to the apparatus participating in the transmission/reception of the video data, “another apparatus” is not stored in the partner communication apparatus information 11e corresponding to the communication types audio transmission and audio reception, and instead information for identifying the apparatus participating in the transmission/reception of the audio data is stored. Accordingly, the session finishing processing of the videophone communication can be performed, for example.

In the foregoing description, the transmitted/received information are video data and audio data. However, the present invention is not limited to these types of data. For example, character data may also be transmitted/received.

In the foregoing description, the first mobile communication apparatus MS1 and the second mobile communication apparatus MS2 are connected to the mobile communication network NW1, and the personal computer PC is connected to the Internet network NW2. However, the present invention is not limited to this case. The first mobile communication apparatus MS1, the second mobile communication apparatus MS2 and the personal computer PC may be connected to the communication network NW, and it is not important whether they are connected to the mobile communication network NW1 or the Internet network NW2.

When the mobile communication apparatus MSi is connected to the Internet network NW2, the mobile communication apparatus MSi has a WLAN (Wireless Local Area Network) connection portion (not shown), and is connected to the Internet network NW2 through the WLAN portion. Furthermore, when the personal computer PC is connected to the mobile communication network NW1, the personal computer PC has a radio communication unit (not shown), and is connected to the mobile communication network NW1 through the radio communication unit.

Furthermore, the communication system according to this embodiment may be constructed to have an SIP (Session Initiation Protocol) server (not shown) connected to the communication network NW. The SIP sever stores the connection relationship of the communication session among the first mobile communication apparatus MS1, the second mobile communication apparatus MS2 and the personal computer PC, and the type of the information to be transmitted/received among the apparatuses. That is, it stores the information which integrates the session statuses information 11b of the respective apparatuses.

Therefore, the first mobile communication apparatus MS1, the second mobile communication terminal MS2 and the personal computer PC store the session identifier 11c, and inquire to the SIP server by indicating the session identifier 11c, thereby obtaining the same information as obtained by referring to the session status information 11b. Accordingly, it is unnecessary to manage plural communication sessions. Furthermore, by notifying the session identifier 11c to the SIP server, the session identified by the session identifier 11c can be finished.

The SIP server may be an apparatus which is provided when the communication network NW includes the Internet network NW2 and is managed by the mobile communication carrier when the communication network NW includes the mobile communication network NW1.

Furthermore, in addition to the SIP server, the communication system according to this embodiment of the present invention may be constructed to have a media server (not shown) which is connected to the communication network NW and performs data transfer. The media server inquires about the video data and the audio data transmitted from the first mobile communication apparatus MS1, the second mobile communication apparatus MS2 and the personal computer PC to the SIP server, and then transfers the data to a proper apparatus in the first mobile communication apparatus MS1, the second mobile communication apparatus MS2 and the personal computer PC.

Furthermore, the media server executes the processing by which the time during which no picture is displayed is shortened, so that the user using the apparatus does not feel discomfort when the switching operation is carried out. The same apparatus as the SIP server may also serve as the SIP (Session Initiation Protocol) server.

In the foregoing description, when the second mobile communication apparatus MS2 switches the transmission/reception of video data to/from the first mobile communication apparatus MS1, which is executed by the second mobile communication apparatus MS2 itself, to the transmission/reception of the video data with the first mobile communication apparatus MS1, which is executed by the personal computer PC during the videophone communication between the first mobile communication apparatus MS1 and the second mobile communication apparatus MS2, the information identifying the personal computer PC is obtained by the predetermined key operation of the input device 16 of the second mobile communication apparatus MS2. This information is transmitted as the parameter to the first mobile communication apparatus MS1, and the controller 11 of the first mobile communication apparatus MS1 is used to perform the communication with the personal computer PC. However, the present invention is not limited to this style.

The controller 11 of the first mobile communication apparatus MS1 may obtain the information for identifying the personal computer PC by the following means. First, the controller 11 of the first mobile communication apparatus MS1 obtains the information for identifying the personal computer PC by a predetermined key operation of the input device 16 of the first mobile communication apparatus MS1, and stores the obtained information in the controller 11 in association with the information for identifying the second mobile communication apparatus MS2 in advance.

Secondly, the controller 11 of the first mobile communication apparatus MS1 receives the information identifying the personal computer PC transmitted from the second mobile communication apparatus MS2, and stores the received information in the controller 11 in association with the information identifying the second mobile communication apparatus MS2.

Thirdly, a switching information server (not shown) connected to the communication network NW stores the information identifying the second mobile communication apparatus MS2 and the information identifying the personal computer PC in association with each other in advance. The controller 11 of the first mobile communication apparatus MS1 requests the switching information server to obtain the associated information and store it into the controller 11 in advance.

Fourthly, the controller 11 of the first mobile communication apparatus MS1 requests the switching information server to obtain the associated information when performing the communication with the personal computer PC. The SIP server may also serve as the switching information server, or the media server may also serve as the switching information server.

In the foregoing description, the mobile communication apparatus MSi has the telephone unit 14c, etc. for performing audio communication, and the encoder 17, the decoder 18, etc. for performing the videophone communication. However, the present invention is not limited to this style. The audio processing unit 14c, etc. for performing audio communication may not be provided, and the audio communication may be performed by stopping the transmission/reception of pictures by the videophone communication.

Furthermore, a portion for performing audio communication and a portion for performing videophone communication may be provided, and one speaker may serve as the speaker 14a and the speaker 18a. Furthermore, one microphone may serve as the microphone 14b and the microphone 17b. The present invention is not limited to the above construction, and various modifications may be made.

What is claimed is:

1. A mobile communication apparatus, comprising:
a radio interface configured to establish a communication session with a base station;
a communication unit configured to receive encoded video data and encoded audio data from a first communication apparatus via the communication session;
a session control unit configured to request the first communication apparatus to transmit one of the encoded video data and the encoded audio data to a second communication apparatus;
a decoding unit configured to decode the encoded video data and the encoded audio data; and
a decoding control unit configured to stop decoding the encoded video data and encoded audio data designated by the session control unit.

2. The mobile communication apparatus according to claim 1, further comprising:
a session management table which stores session identification information and apparatus information indicating the apparatus with which the encoded video data is communicated and the apparatus with which the encoded audio data is communicated.

3. The mobile communication apparatus according to claim 1, wherein the decoding control unit stops decoding the one of the encoded video data and the encoded audio data if the session control unit receives notification information indicating that the one of the encoded video data and the encoded audio data is addressed to the designated second communication apparatus.

4. The mobile communication apparatus according to claim 1, wherein the encoded video data and the encoded audio data are received during a videophone communication.

5. A mobile communication apparatus, comprising:
a radio interface configured to establish a communication session with a base station;
a communication unit configured to transmit encoded video data and encoded audio data to a first communication apparatus via the communication session; and
session control unit configured to receive a request from the first communication apparatus for transmitting one of the encoded video data and encoded audio data to a second communication apparatus,
wherein, the communication unit transmits the requested one of the encoded video data and the encoded audio data to the second communication apparatus if the request is received from the first communication apparatus.

6. The mobile communication apparatus according to claim 5, further comprising:
a session management table which stores session identification information and apparatus information indicating the apparatus with which the encoded video data is communicated and the apparatus with which the encoded audio data is communicated.

7. The mobile communication apparatus according to claim 5, wherein the session control unit transmits notification information to the first communication apparatus to indicate that the requested one of the encoded video data and the encoded audio data is addressed to the designated second communication apparatus.

8. The mobile communication apparatus according to claim 5, wherein the encoded video data and the encoded audio data are transmitted during a videophone communication.
